(19) United States
(12) Patent Application Publication
(10) Pub. No.: US 2014/0310377 A1
(43) Pub. Date: Oct. 16, 2014

(54) INFORMATION PROCESSING METHOD AND INFORMATION PROCESSING APPARATUS

(71) Applicant: Fujitsu Limited, Kawasaki-shi (JP)

(72) Inventor: Naoki MATSUOKA, Kawasaki (JP)

(73) Assignee: Fujitsu Limited, Kawasaki-shi (JP)

(21) Appl. No.: 14/249,681

(22) Filed: Apr. 10, 2014

(30) Foreign Application Priority Data
Apr. 15, 2013 (JP) 2013-084612

(51) Int. Cl. H04L 29/08

(52) U.S. Cl. CPC H04L 67/02
USPC 709/217

(57) ABSTRACT

An information processing method including transmitting, via a first communication device of a plurality of communication devices configured to couple a plurality of information processing apparatuses, a control packet to a first information processing apparatus of the plurality of information processing apparatuses based on a deployment of a first virtual machine to the first information processing apparatus; obtaining, from the first communication device, correspondence data between a port identifier and a destination address regarding a first group to which the first virtual machine belongs; and extracting, from the correspondence data, a first destination address relating to a first identifier of the first communication device and a first port identifier of the first communication device.

### CROSS-REFERENCE TO RELATED APPLICATION

This application is based upon and claims the benefit of priority from the prior Japanese Patent Application No. 2013-084612 filed on Apr. 15, 2013, the entire contents of which are incorporated herein by reference.

### FIELD

Embodiments discussed herein are related to technologies that cope with network failure.

### BACKGROUND

In cloud computing environment, a desired information and communication technology (ICT) system is created by combining virtual servers (virtual machines) that are constructed utilizing computer resources on a network.

The cloud computing environment provides a virtually-independent environment for each of a plurality of tenants (groups such as corporations, business units, users, and the like). In this virtually-independent environment, network isolation (limitations on the reachable range of data packets) is securely established for each tenant while sharing computing resources (physical servers) with other tenants.

Japanese Laid-open Patent Publication No. 2000-253041 discusses related art. The related art is also discussed in a non-patent document: Masuda, Hideo, et al., “Implementation of a port-aware DHCP server using FDB in the Switching HUB”, Technical Reports of Information Processing Society of Japan, 2005-DSM-37(8), pp. 41-46.

### SUMMARY

According to an aspect of the invention, an information processing method including transmitting, via a first communication device of a plurality of communication devices configured to couple a plurality of information processing apparatuses, a control packet to a first information processing apparatus of the plurality of information processing apparatuses based on a deployment of a first virtual machine to the first information processing apparatus; obtaining, from the first communication device, correspondence data between a port identifier and a destination address regarding a first group to which the first virtual machine belongs; and extracting, from the correspondence data, a first destination address relating to a first identifier of the first communication device and a first port identifier of the first communication device.

The object and advantages of the embodiments will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a system;

FIG. 2 illustrates an example of a function of a management server;

FIG. 3 illustrates an example of functions of a host;

FIG. 4A illustrates an example of a system process;

FIG. 4B illustrates an example of a request packet format;

FIG. 4C illustrates an example of data to be registered in a switch FDB;

FIG. 4D illustrates an example of data to be registered in a switch FDB;

FIG. 5A illustrates an example of a system process;

FIG. 5B illustrates an example of a response-to-request packet format;

FIG. 5C illustrates an example of data to be registered in a switch FDB;

FIG. 5D illustrates an example of an ACK packet format;

FIG. 5E illustrates an example of an ACK packet format;

FIG. 5F illustrates an example of data to be registered in a switch FDB;

FIG. 5G illustrates an example of pseudo FDB data to be retained in a host;

FIG. 5H illustrates an example of pseudo FDB data to be retained in a host;

FIG. 6 illustrates an example of a system process;

FIG. 7 illustrates an example of a correspondence table;

FIG. 8 illustrates an example of failure incident;

FIG. 9 illustrates an example of a management server process;

FIG. 10 illustrates an example of a process of a control packet process section;

FIG. 11A illustrates an example of a control packet format;

FIG. 11B illustrates an example setting of a source MAC address and a destination MAC address;

FIG. 11C illustrates an example setting of a source IP address and a destination IP address;

FIG. 11D illustrates an example setting of a control packet identifier;

FIG. 12 illustrates an example process of a control packet process section;

FIG. 13 illustrates an example process at time of failure incident detection;

FIG. 14 illustrates an example of function blocks of a host;

FIG. 15A illustrates an example of a request packet format;

FIG. 15B illustrates an example of a response-to-request packet format;

FIG. 15C illustrates an example of an ACK packet format;

FIG. 16A illustrates an example of tunneling technology;

FIG. 16B illustrates an example of tunneling technology;

FIG. 17 illustrates an example of a control packet format;

FIG. 18 illustrates an exemplary network of link aggregation;

FIG. 19A illustrates an example of data included in a switch;

FIG. 19B illustrates an example of data included in a switch;

FIG. 19C illustrates an example of data included in a switch;

FIG. 19D illustrates an example of data included in a switch;

FIG. 19E illustrates an example of data included in a pseudo of host;

FIG. 19F illustrates an example of data included in a pseudo of host; and

FIG. 20 illustrates an example of function blocks of a computer.

### DESCRIPTION OF EMBODIMENTS

In the cloud computing environment, many users share computing resources. Thus the resources are efficiently utilized, and the cost of investment is reduced. However, when a failure occurs in the computing resources, the failure may affect a plurality of users. Accordingly, it is desirable to swiftly determine effects of failure when a failure occurs.

To determine a failure location, it is determined what kinds of devices are coupled to a network. For example, in such a determination, data stored in forwarding databases (FDB), which are included in switches and hubs in the network, are utilized. However, in the FDB, entries are deleted when no communication takes place for a certain period of time. Thus, any host (physical server) that is not in communication at the time of failure may not be registered in the FDB and ignored.

Many physical servers that provide several tens to hundreds of virtual machines are in operation in a data center owned by a large company or a cloud service provider.

In this type of data center, a tunneling technology such as Generic Routing Encapsulation (GRE), Virtual eXtensible Local Area Network (VXLAN), Network Virtualization using Generic Routing Encapsulation (NVGRE), or the like is used to secure the network isolation for each tenant.

A virtual local area network (VLAN) serving as the isolation technology may not accommodate more than 4096 tenants. Thus, the tunneling technology is adopted in a larger environment. However, tunneling is performed in the tunneling technology, and MAC addresses of respective virtual machines may not be registered in the FDB.

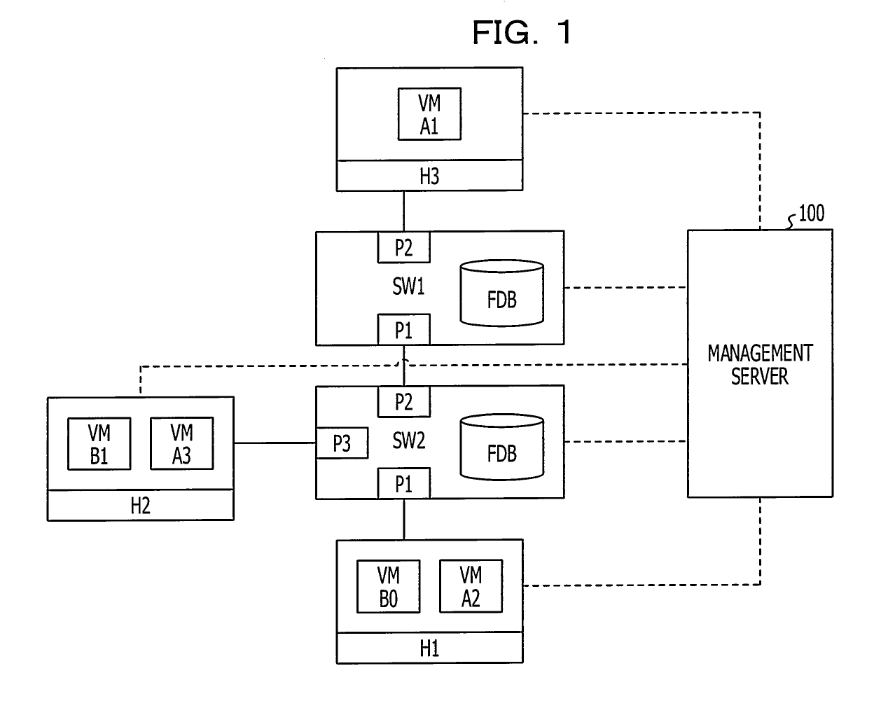

FIG. 1 illustrates an example of a system. As illustrated in FIG. 1, Hosts H1 to H3 that serve as physical machines are coupled by use of switches SW1 and SW2. The switches SW1 and SW2 each include a FDB. Configurations of the switches SW1 and SW2 may be, for example, substantially the same as or similar to that of a conventional switch. For example, in the host H1, a virtual machine B0 of a tenant B and a virtual machine A2 of a tenant A are running. For example, in the host H2, a virtual machine A3 of the tenant A and a virtual machine B1 of the tenant B are running. For example, in the host H3, a virtual machine A1 of the tenant A is running. The hosts H1 to H3 are each provided with a control packet process section.

A port P2 of the switch SW1 is coupled to the host H3. A port P1 of the switch SW1 is coupled to a port P2 of the switch SW2. A port P3 of the switch SW2 is coupled to the host H2. A port P1 of the switch SW2 is coupled to the host H1.

The hosts H1 to H3 and the switches SW1 and SW2 are coupled to a management server 100 through, for example, a management local area network (LAN). The management server 100 manages virtual machines running on the hosts H1 to H3, and controls migrating, starting, shutting down of virtual machines, or performs any other control. The management server 100 performs a process for accumulating data indicative of correspondences between the media access control (MAC) addresses of virtual machines and the port numbers in the FDBs of the switches SW1 and SW2, and collects the correspondence data accumulated in the FDBs. When a failure is detected in the network, the management server 100 generates data from the collected correspondence data to determine the extent of effect of the failure.

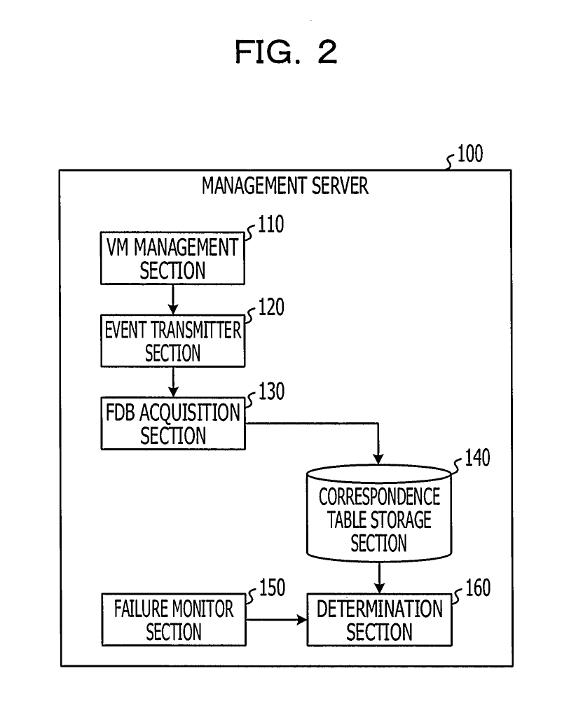

FIG. 2 illustrates an example of a function of a management server. The management server 100 includes a VM management section 110, an event transmitter section 120, a FDB acquisition section 130, a correspondence table storage section 140, a failure monitor section 150, and a determination section 160.

The VM management section 110 controls migrating, starting, shutting down of virtual machines, or performs any other control, and further stores data regarding which virtual machine is being started on which host. The VM management section 110 may perform a conventional process. When the VM management section 110 migrates or deploys a virtual machine, the event transmitter section 120 transmits a control packet to a control packet process section of a host to which the virtual machine is migrated or deployed. The control packet includes a tenant ID of a tenant to which the virtual machine belongs, and indicates the occurrence of an event.

The FDB acquisition section 130 obtains FDB data from each of the switches SW1 and SW2, obtains data similar to the FDB from the control packet process section of each host, and registers obtained data in a correspondence table of the correspondence table storage section 140.

The failure monitor section 150 monitors a network to detect a failure, and outputs data indicative of a failure location to the determination section 160 when the failure monitor section 150 detects a failure. Based on the failure location notified by the failure monitor section 150 or the like, the determination section 160 extracts related data stored in the correspondence table, generates data indicative of the extent of failure effect, and outputs the generated data to another computer or an output apparatus such as a display apparatus or the like.

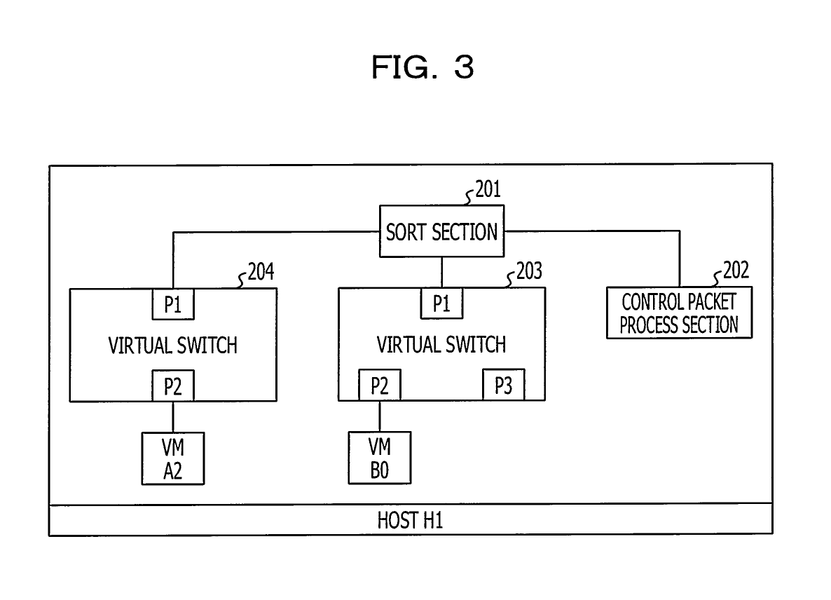

FIG. 3 illustrates an example of function blocks of a host. FIG. 3 illustrates function blocks of the host H1 illustrated in FIG. 1. The host H1 includes a sort section 201, virtual switches 203 and 204, a control packet process section 202, and the virtual machines A2 and B0. The sort section 201 outputs a received packet to one of the virtual switch 204, the virtual switch 203, and the control packet process section 202 based on VLANID (or tunnel ID) and a packet type, or the like. The virtual switch 204 may be a virtual switch for the tenant A. A port 1 of the virtual switch 204 may be coupled to the sort section 201, and a port 2 of the virtual switch 204 may be coupled to the virtual machine A2. The virtual switch 203 may be a virtual switch for the tenant B. A port 1 of the virtual switch 203 may be coupled to the sort section 201, and a port 2 of the virtual switch 203 may be coupled to the virtual machine B0.

The control packet process section 202 is aware of the virtual machine running on its own host, and exchanges the control packet. The virtual machine running on its own host may be determined based on, for example, a message from the VM management section 110 of the management server 100 or the like. The sort section 201 and the control packet process section 202 may be included in an operating system (OS) of host.

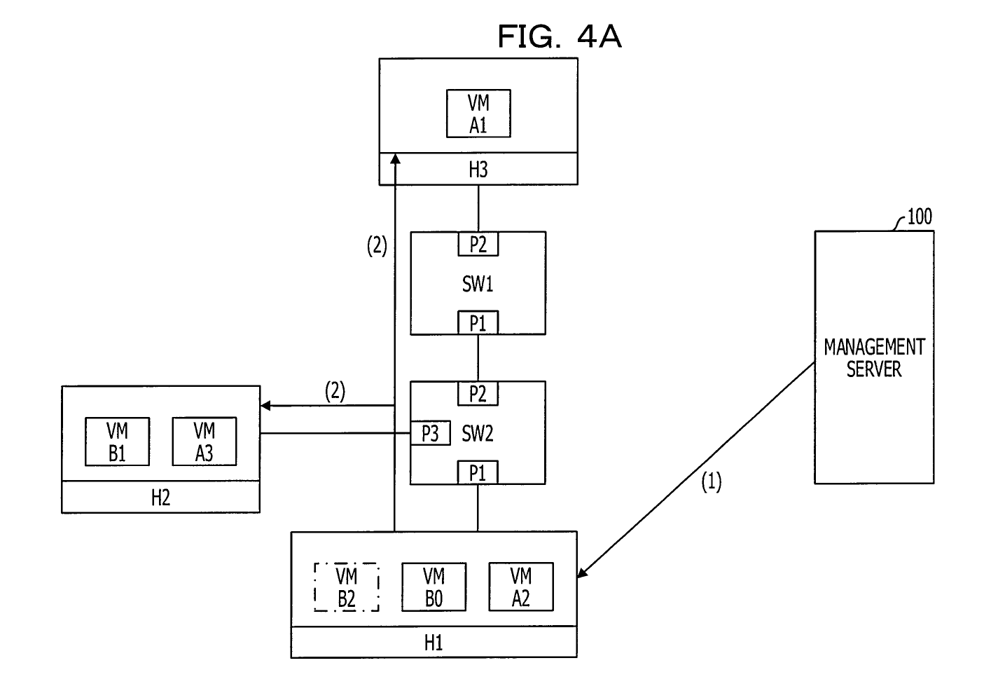

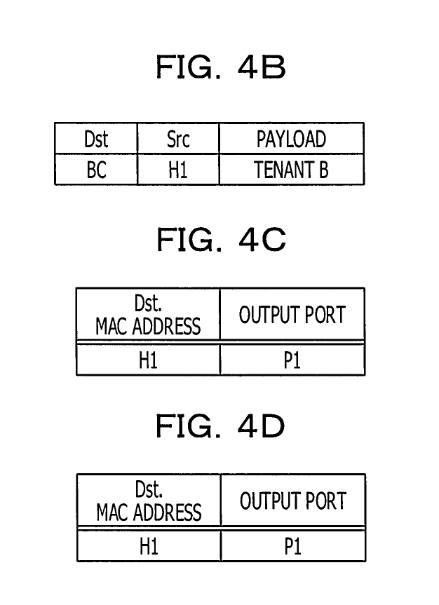

A system operation is described with reference to FIG. 4A to FIG. 13.

FIG. 4A illustrates an example of a system process. FIG. 4B illustrates an example of a request packet format. FIG. 4C illustrates an example of data to be registered in the switch FDB. FIG. 4D illustrates an example of data to be registered in the switch FDB. For example, the VM management section 110 deploys the virtual machine B2 of the tenant B to the host H1. The VM management section 110 outputs a tenant ID and an identifier to the event transmitter section 120 after the deployment of the virtual machine B2 to the host H1. The tenant ID indicates the tenant to which the virtual machine B2 belongs, and the identifier indicates the host H1 that serves as the deployment destination. As illustrated in FIG. 4A, the event transmitter section 120 transmits an event message that is a control packet and includes the tenant ID to the deployment destination host H1 (operation (1)). When the event message is received from the management server 100, the control packet process section 202 of the deployment destination host H1 broadcasts a request packet (operation (2)).

The request packet includes, as illustrated in FIG. 4B, a broadcast address as a destination address (Dst), the address of the host H1 as a source address (Src), and a tenant ID ‘Tenant B’ in a payload. Data illustrated in FIG. 4C are registered in the FDB of the switch SW2. For example, the source address is registered as the destination address, and the port number of a reception port for the request packet is registered.

The control packet process sections 202 of the hosts H2 and H3 that received the request packet each determine whether or not the virtual machine of the tenant ID included in the payload of the request packet is running on its own host. For example, the virtual machine of the tenant B is not running on the host H3. Thus, the control packet process section 202 of the host H3 may perform no process on the request packet.

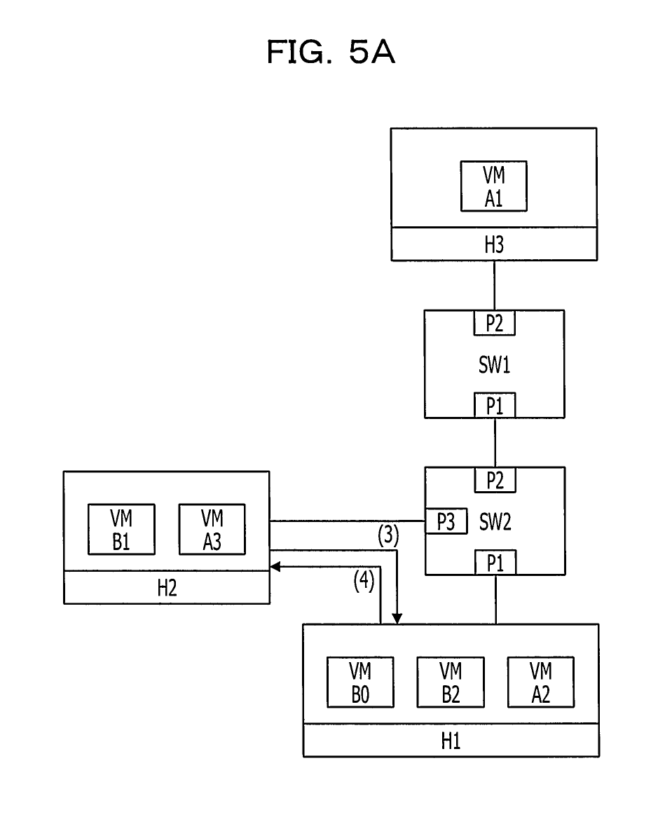

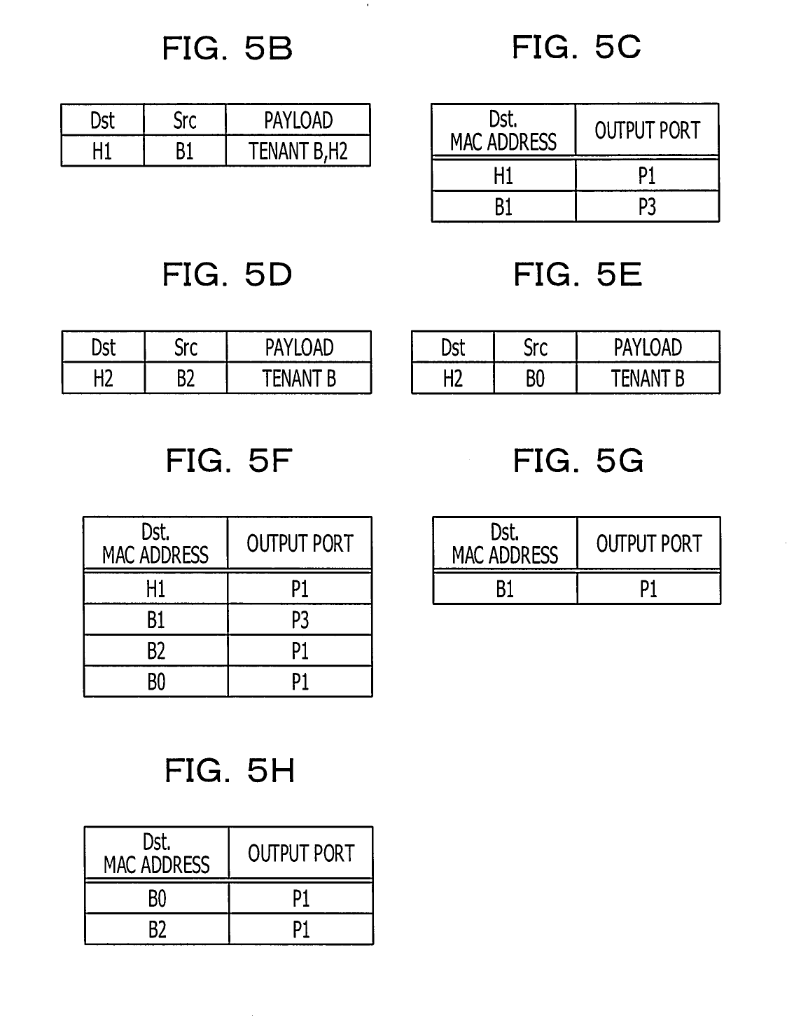

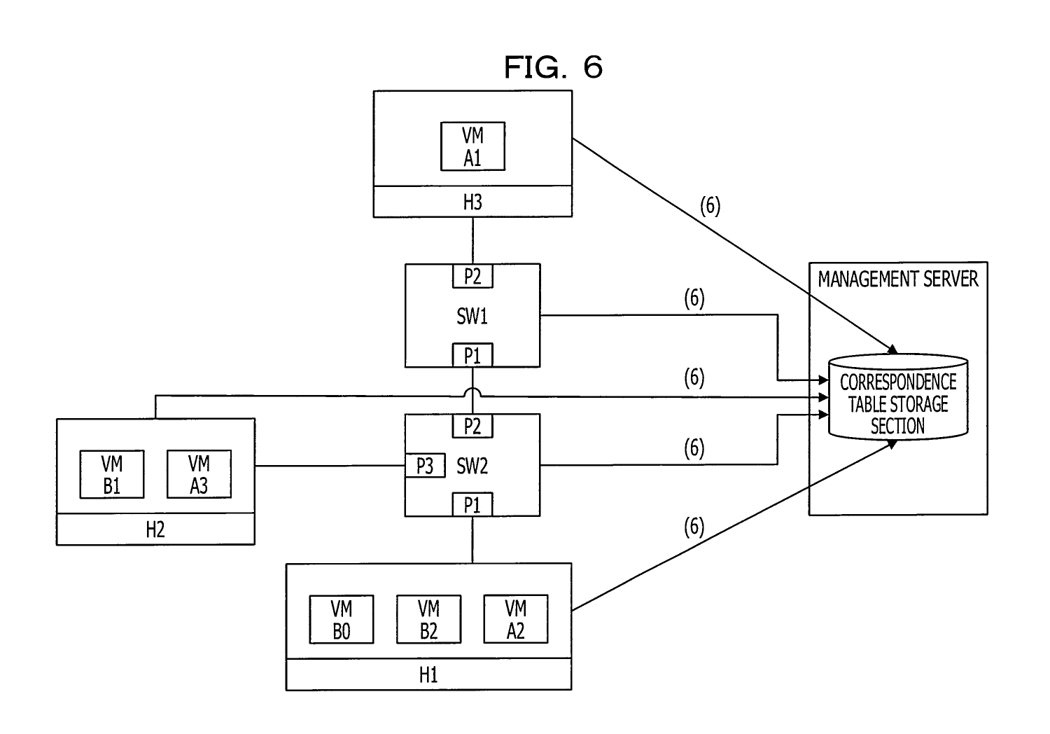

FIG. 5A illustrates an example of a system process. FIG. 5B illustrates an example of a response-to-request packet format. FIG. 5C illustrates an example of data to be registered in the switch FDB. FIG. 5D illustrates an example of an ACK packet format. FIG. 5E illustrates an example of an ACK packet format. FIG. 5F illustrates an example of data to be registered in a switch FDB. FIG. 5G illustrates an example of pseudo FDB data to be retained in a host. FIG. 5H illustrates an example of pseudo FDB data to be retained in a host. In the host H2, the virtual machine B1 of the tenant B is running. Thus, as illustrated in FIG. 5A, the control packet process section 202 of the host H2 transmits a response-to-request packet to the source address of the request packet as a response to the request packet (operation (3)). For example, the MAC address of the virtual machine B1 of the tenant B may be used as the source address of the response-to-request packet. When a plurality of virtual machines of the tenant B is running, the response-to-request packet may be transmitted to each virtual machine.

The response-to-request packet includes, as illustrated in FIG. 5B, the MAC address ‘H1’ of the host H1 as the destination address (Dst), the MAC address ‘B1’ of the virtual machine 61 as the source address (Src), and the tenant ID ‘Tenant B’ and the address of the source host ‘H2’ in the payload. The MAC address ‘B1’ of the virtual machine B1 is used as the source address. Thus, the payload includes the MAC address of the host H2 for setting the destination of an ACK packet to be transmitted as a response to the response-to-request packet.

Data illustrated in FIG. 5C may be registered in the FDB of the switch SW2. For example, the source address ‘B1’ of the response-to-request packet is registered as the destination address, and the port number ‘P3’ of the port received the response-to-request packet is registered as the port number of an output port.

The control packet process section 202 of the host H1, which received the response-to-request packet, identifies the virtual machines B0 and B2 of the tenant B that belong to the tenant ID ‘B’ included in the payload of the response-to-request packet and that are running in its own host H1. The control packet process section 202 transmits, as illustrated in FIG. 5A, an ACK packet including the virtual machine B0 as the source address (Src) and an ACK packet including the virtual machine B2 as the source address (Src) to the source host ‘H2’ that is included in the response-to-request packet (operation (4)).

The ACK packet includes, as illustrated in FIG. 5D, the MAC address ‘H2’ of the host H2 as the destination address (Dst), the MAC address ‘B2’ of the virtual machine B2 as the source address (Src), and the tenant ID ‘Tenant B’ in the payload. Another ACK packet includes, as illustrated in FIG. 5E, the MAC address ‘H2’ of the host H2 as the destination address (Dst), the MAC address ‘B0’ of the virtual machine B0 as the source address (Src), and the tenant ID ‘Tenant B’ in the payload.

Data such as illustrated in FIG. 5F are registered in the FDB of the switch SW2. For example, the source address ‘B2’ of the ACK packet is registered as the destination address, and the port number ‘P1’ of the port which has received the ACK packet is registered as the port number of the output port. The source address ‘B0’ of the ACK packet is registered as the destination address, and the port number ‘P1’ of the port which has received the ACK packet is registered as the port number of the output port.

As illustrated in FIG. 5G, the control packet process section 202 of the host H1 that has received the response-to-request packet retains, as pseudo FDB data, the MAC address ‘B1’ as the source address of the response-to-request packet and a corresponding port ‘P1’ as the port number of a virtual port that has received this response-to-request packet.

Similarly, as illustrated in FIG. 5H, the control packet process section 202 of the host H2 that has received two ACK packets retains, as pseudo FDB data, the MAC addresses ‘B0’ and ‘B2’ as the source addresses of the ACK packet and the corresponding ports ‘P1’ as the port numbers of virtual ports that has received these ACK packets.

At the time of deploying or migrating a virtual machine, the MAC addresses of the virtual machines that belong to the same tenant and are running on the hosts are registered in the FDB of the physical switch as well as in the pseudo FDB of each host.

FIG. 6 illustrates an example of a system process. As illustrated in FIG. 6, the FDB acquisition section 130 of the management server 100 obtains FDB data from the switches SW1 and SW2 by use of simple network management protocol (SNMP) or the like after the transmission of the event message from the event transmitter section 120 and the elapse of a certain time period, and stores obtained FDB data in the correspondence table storage section 140 (operation (6)). Here, the MAC address of host is not used. Thus, the MAC address of host may be excluded, and the MAC address may be narrowed down to that of the tenant who sent the current event message.

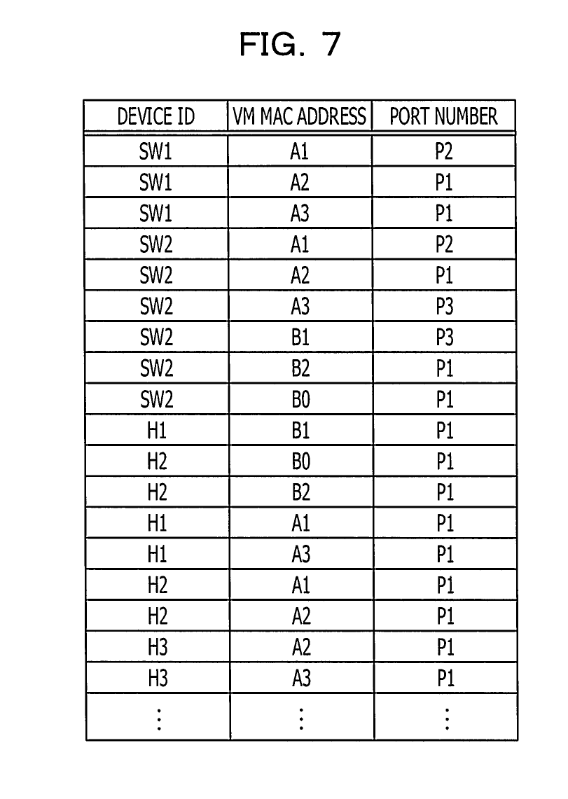

FIG. 7 illustrates an example of a correspondence table. For example, the correspondence table storage section 140 may store data illustrated in FIG. 7. For example, as illustrated in FIG. 7, a device ID, the MAC address of VM, and the port number are registered. The device ID may be assigned not only to switches but also to hosts. In the case of host, the port number may be of a virtual port.

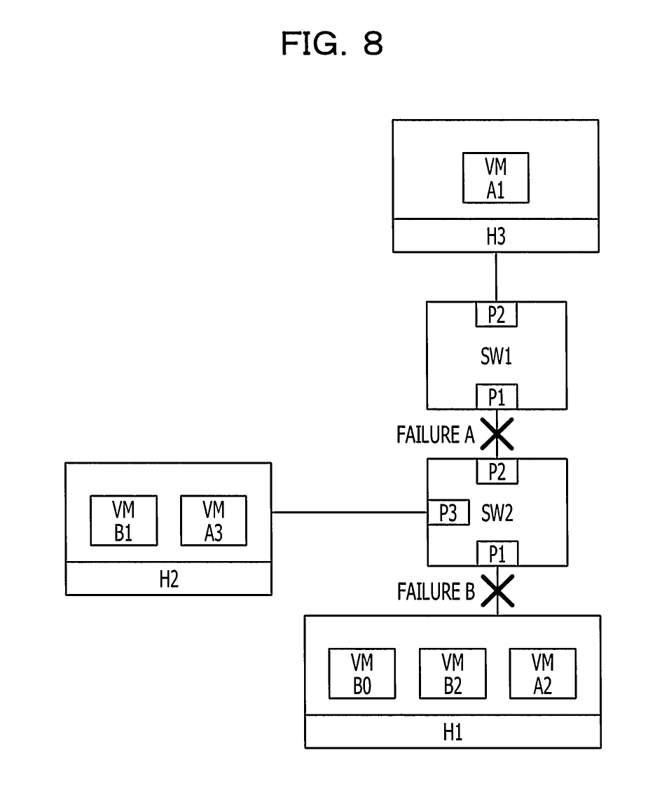

FIG. 8 illustrates an example of failure incident. For example, as illustrated in FIG. 8 as a failure A, when the failure monitor section 150 detects that a link between the switch SW2 and the switch SW1 is down, the failure monitor section 150 identifies the switch SW1 and its port ‘P1’ and the switch SW2 and its port ‘P2’ as related device IDS and the port numbers, respectively. This data are output to the determination section 160. The determination section 160 conducts a search for a correspondence table based on the data from the failure monitor section 150, and extracts data. For example, in FIG. 7, ‘A2’ and ‘A3’ are extracted for ‘SW1’ and ‘P1’ whereas ‘A1’ is extracted for ‘SW2’ and ‘P2’. When combinations are formed for the same tenant, a combination of ‘A1’ and ‘A2’ and a combination of ‘A1’ and ‘A3’ are identified as the extent of failure effect.

For example, as illustrated as a failure B of FIG. 8, when the failure monitor section 150 detects that a link between the switch SW2 and the host H1 is down, the failure monitor section 150 identifies the switch SW2 and its port ‘P1’ and the host H1 and its port ‘P1’ as the related device IDS and the port numbers. The data are output to the determination section 160. The determination section 160 conducts a search for a correspondence table based on the data from the failure monitor section 150, and extracts data. In FIG. 7, ‘A2’, ‘B2’, and ‘B0’ are extracted for ‘SW2’ and ‘P1’ whereas ‘A1’, ‘A3’, and ‘B1’ are extracted for ‘H1’ and ‘P1’. When the combination is considered for the same tenant, a combination of ‘A2’ and ‘A1’, a combination of ‘A2’ and ‘A3’, a combination of ‘B1’ and ‘B2’, and a combination of ‘B1’ and ‘B0’ are identified as the failure extent.

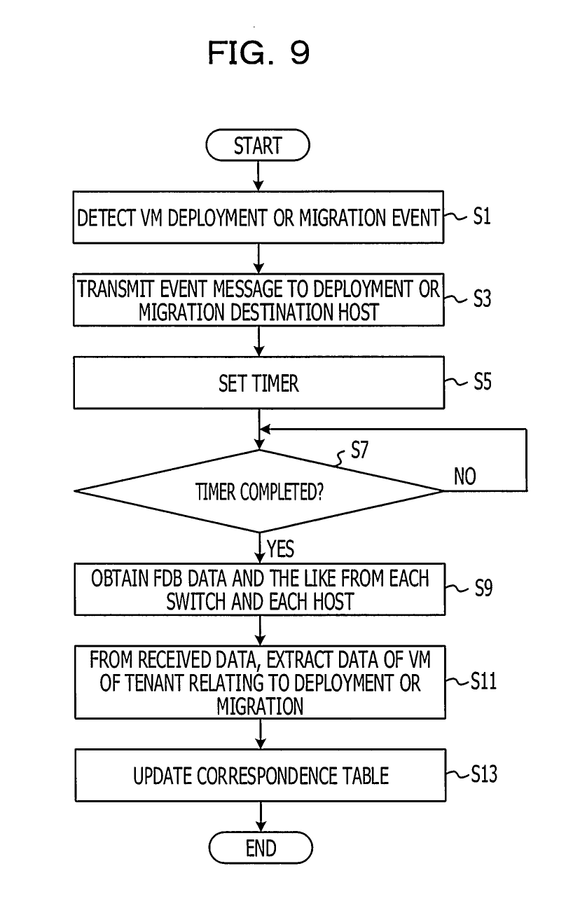

FIG. 9 illustrates an example of a management server process. When the VM management section 110 requests a deployment or migration of virtual machine, the VM management section 110 outputs to the event transmitter section 120 the identifier of a destination host to which the virtual machine is deployed or migrated and the tenant ID of a tenant to which the virtual machine belongs. The event transmitter section 120 detects a deploying event or a migrating event of a virtual machine (FIG. 9: operation S1), and transmits an event message including the tenant ID of the tenant, to which the virtual machine belongs, to the control packet process section 202 of the deployment or migration destination host (operation S3). The event transmitter section 120 outputs the tenant ID to the FDB acquisition section 130.

Upon receipt of the tenant ID, the FDB acquisition section 130 sets a timer (operation S5), and waits until the timer completes (operation S7). During this period, the control packet process section 202 of each host coupled to the network performs, for example, the foregoing control packet exchange on behalf of the virtual machine running on its own host.

When the timer completes, the FDB acquisition section 130 obtains FDB data (including pseudo FDB data) from each switch and each host (operation S9). For the physical switch, the FDB data are obtained by use of SNMP or the like. For the host, a request is transmitted to the control packet process section 202, and the pseudo FDB data are transmitted in response to that request.

The FDB acquisition section 130 extracts, from the received data, data of the virtual machine that belongs to the tenant relating to the deployment or the migration (operation S11). For example, data including the MAC address regarding the host are not related to the following process, and may be excluded. Data of the virtual machine that belongs to another tenant may not be the latest, and thus may be also excluded. The exclusion process may be performed based on a MAC address assignment condition when the MAC address assignment condition is controlled.

The FDB acquisition section 130 updates corresponding data stored in the correspondence table storage section 140 with the extracted data in the operation S11 (operation S13). For example, in the correspondence table, the data on the tenant relating to the migration and the deployment are discarded, and the data newly-obtained are overwritten.

According to the execution of the foregoing process, the latest deployment state is reflected in the FDB at the timing of virtual machine deployment or migration. Thus, the latest version of the correspondence table may be maintained as much as possible.

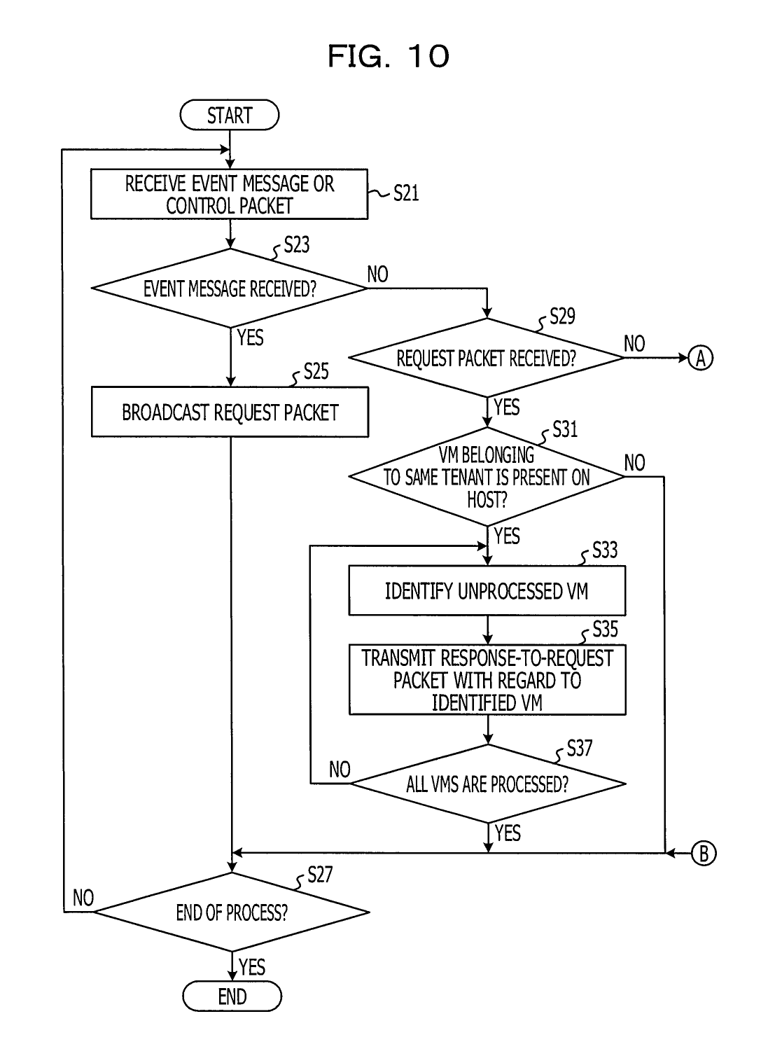

FIG. 10 illustrates an example of process of a control packet process section. The control packet process section 202 receives an event message or a control packet from another host or the management server 100 (FIG. 10: operation S21).

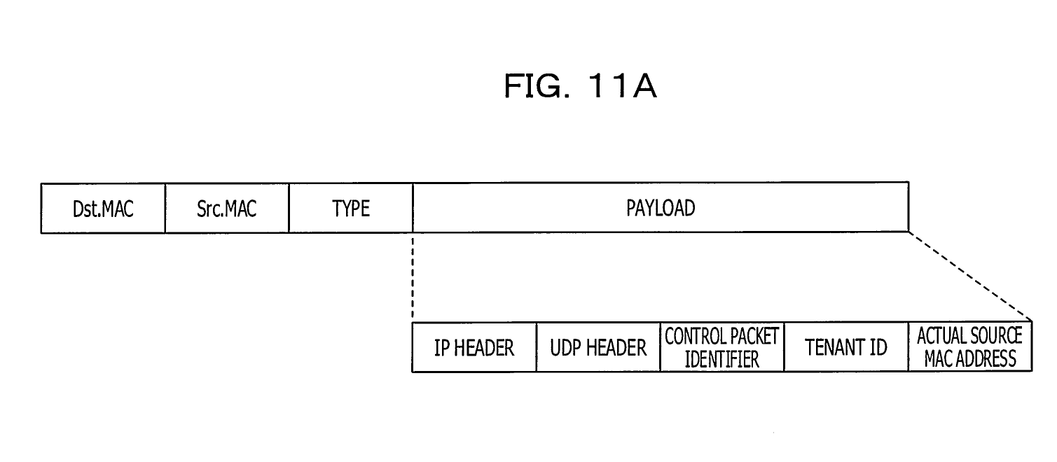

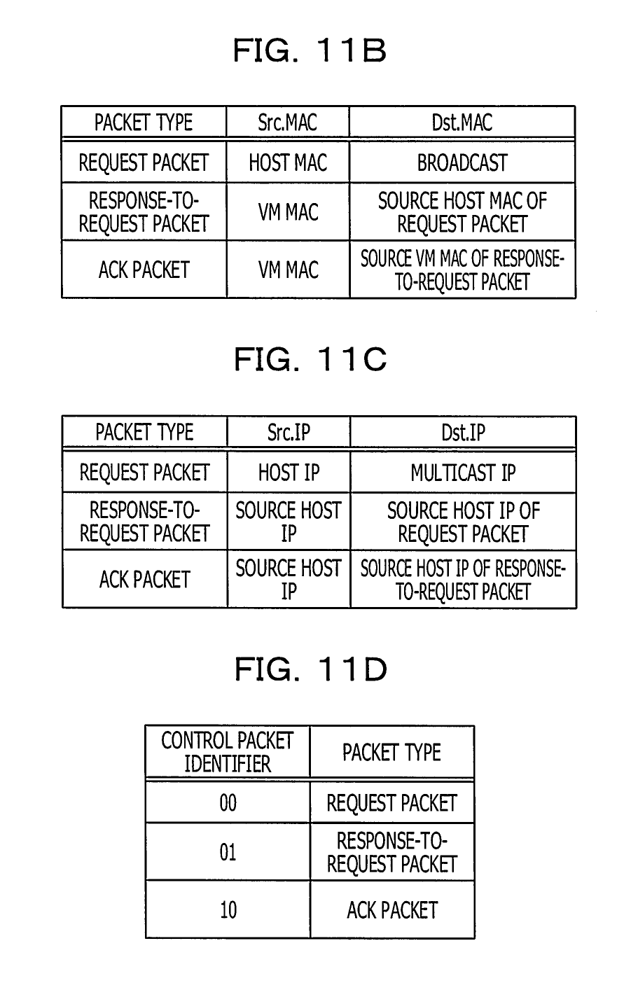

FIG. 11A illustrates an example of a control packet format. FIG. 11B illustrates an example of setting of a source MAC address and a destination MAC address. FIG. 11C illustrates an example of setting of a source IP address and a destination IP address. FIG. 11D illustrates an example of setting of a control packet identifier. The control packet illustrated in FIG. 11A includes a destination MAC address (Dst. MAC), a source MAC address (Src. MAC), a type such as, for example, a control packet identifier, and a payload. The payload includes an IP header, a UDP header, the control packet identifier, the tenant ID, and an actual source MAC address. The actual source MAC address may be enabled in the case of the response-to-request packet.

The source MAC address and the destination MAC address may be set as illustrated in FIG. 11B. The source IP address and the destination IP address may be set as illustrated in FIG. 11C. For example, the MAC address in FIG. 11B may be changed to the IP address. The control packet identifier may be set as illustrated in FIG. 11D. The control packet identifier in FIG. 11D may be set to another value. The event message is one kind of the control packet, and its payload may include the tenant ID.

The control packet process section 202 determines whether the received packet is an event message or not (operation S23). When the event message is received, the control packet process section 202 generates and broadcasts a request packet (operation S25). The request packet includes the tenant ID, which is included in the event message, in its payload. Further, in this request packet, the broadcast address is set as the destination MAC address, and the source MAC address includes the MAC address of its own host, as illustrated in FIG. 4B and FIG. 11B. The control packet process section 202 determines if it is an end of process (operation S27). If it is not the end of process, the process returns to the operation S21. If it is the end of process, the process ends.

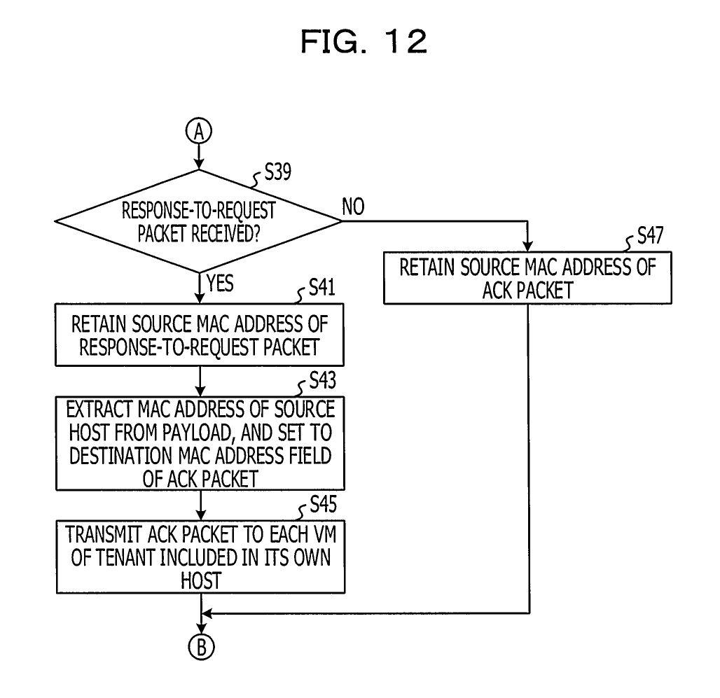

When the received packet is not an event message, the control packet process section 202 determines whether the received packet is a request packet or not (operation S29). When it is not the reception of request packet, the process proceeds to a process of FIG. 12 through a terminator A. FIG. 12 illustrates an example of a process of a control packet process section.

When the request packet is received, the control packet process section 202 determines whether or not there is a virtual machine relating to a tenant that has the same tenant ID as the one included in the payload of the request packet (operation S31). The control packet process section 202 manages virtual machines running on its own host for each tenant by working together with the VM management section 110 of the management server 100 and the like. For example, each tenant may have a list of MAC addresses of virtual machines.

When no virtual machines belonging to the same tenant as the one designated in the request packet are running on its own host, the process proceeds to the operation S27. When there are virtual machines belonging to the same tenant as the one designated in the request packet and running on its own host, the control packet process section 202 identifies one virtual machine among the virtual machines that has not been processed (operation S33). The control packet process section 202 generates and transmits a response-to-request packet (operation S35). The response-to-request packet includes the tenant ID and the MAC address of its own host in the payload. Further, in this response-to-request packet, the MAC address of the identified virtual machine is set as the source MAC address, and the source MAC address of the request packet is set as the destination MAC address. Other settings may be performed based on the formats illustrated in FIGS. 11A to 11D.

The control packet process section 202 determines whether or not all the virtual machines belonging to the same tenant as the one which is designated by the request packet are processed (operation S37). When there is an unprocessed virtual machine, the process returns to the operation S33. When there is no unprocessed virtual machine, the process proceeds to the operation S27.

FIG. 12 illustrates an exemplary process of a control packet process section. The process proceeds to the process of FIG. 12 through the terminator A, and the control packet process section 202 determines whether or not the response-to-request packet is received (operation S39). When the response-to-request packet is received, the control packet process section 202 retains the source MAC address of the response-to-request packet as the pseudo FDB data (operation S41). The control packet process section 202 extracts the MAC address of the source host from the payload, and sets the extracted MAC address to the field of the destination MAC address of the ACK packet (operation S43). The control packet process section 202 transmits the ACK packet to each of the virtual machines that are running on its own host and belong to the tenant designated by the payload of the response-to-request packet (operation S45). In the ACK packet, the MAC address of virtual machine is set as the source MAC address. Where there is a plurality of virtual machines, the ACK packet is transmitted to each of the plurality of virtual machines. The process returns to the operation S27 through a terminator B.

When the ACK packet is received instead of the response-to-request packet (operation S39: ‘NO’ route), the control packet process section 202 retains the source MAC address of the ACK packet as the pseudo FDB data (operation S47). The process returns to the operation S27 through the terminator B.

As described above, the MAC address of the virtual machine relating to the tenant designated by the request packet is set in the switch FDB, and also registered in the pseudo FDB in the control packet process section 202 of the other host. For example, the data illustrated in FIG. 7 are retained in the management server 100.

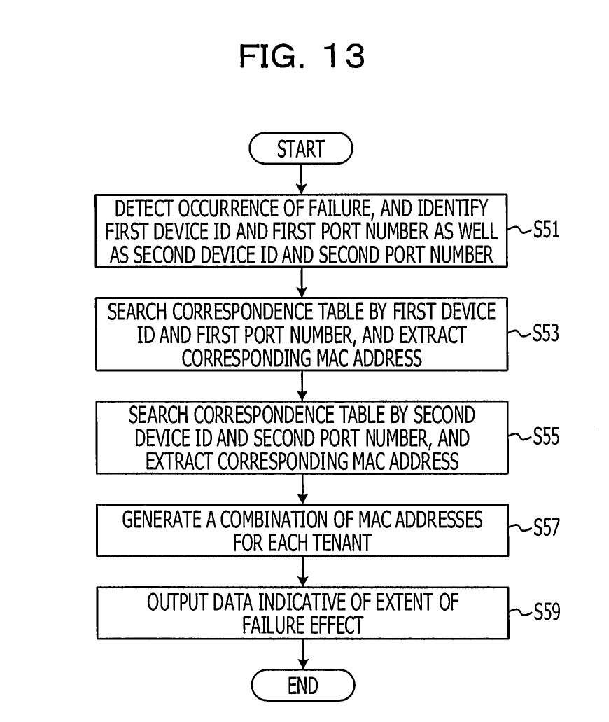

FIG. 13 illustrates an example of a process at time of failure incident detection. When an occurrence of link failure is detected in any one of networks, the failure monitor section 150 identifies a first port number and a first device ID that is a device disposed on one side of the link and a second port number and a second device ID that is a device disposed on the other side of the link, and outputs the identified data to the determination section 160 (operation S51). The failure monitor section 150 uses these data since it has network configuration data.

The determination section 160 searches the correspondence table by the first device ID and the first port number, and extracts a corresponding MAC address (operation S53). The determination section 160 searches the correspondence table by the second device ID and the second port number, and extracts a corresponding MAC address (operation S55). The host device ID and the virtual port number may also be used in searching.

The determination section 160 generates a combination of the extracted MAC addresses for each tenant (operation S57). For each tenant, a combination of the MAC address extracted in the operation S53 and the MAC address extracted in the operation S55 may be generated. Data may be discarded when no combination is generated from that data.

The determination section 160 outputs data indicative of the extent of failure effect that includes data of the combination generated in the operation S57 to an output apparatus or another computer (operation S59).

According to the execution of the foregoing process, precise data regarding the extent of failure effect may be obtained.

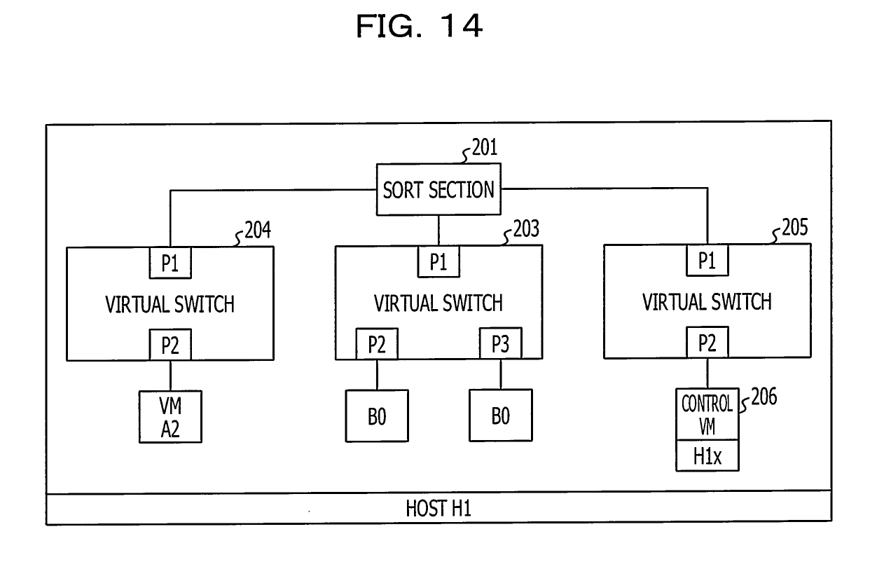

The control packet process section 202 may be included in the OS of host, or may be implemented in the OS of host as a special virtual machine as illustrated in FIG. 14.

FIG. 14 illustrates an example of function blocks of a host. For example, the sort section 201 is coupled to a virtual switch 205. When the packet is a usual packet, the sort section 201 outputs this packet to the virtual switch 204 or 203 depending on a VLANID or a tunneling ID of tunneling technology. When the packet is a control packet (including an event message) that may be identified by a packet type, the sort section 201 outputs this control packet to the virtual switch 205. The control packet may include the event message.

The virtual switch 205 is coupled to a control virtual machine 206. The control virtual machine 206 may have functions substantially the same as or similar to that of the control packet process section 202 illustrated in FIG. 3. The control virtual machine 206 has a MAC address ‘H1x’ that is different from the MAC address ‘H1’ of the host H1.

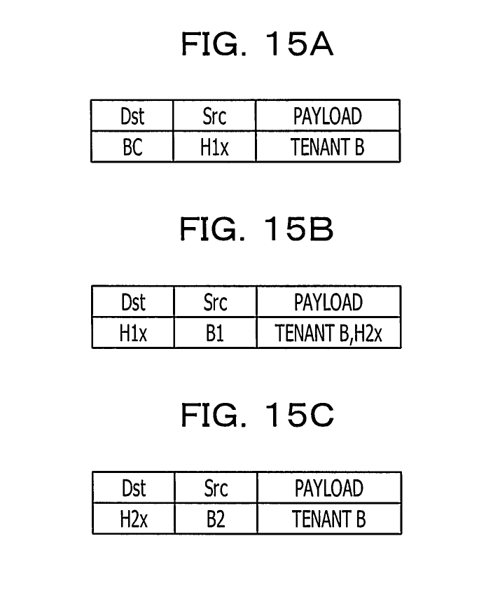

FIG. 15A illustrates an example of a request packet format. FIG. 15B illustrates an example of a reply-to-request packet format. FIG. 15C illustrates an example of an ACK packet format. Although the foregoing configuration is adopted, the process may still have functions substantially the same as or similar to that of the host illustrated in FIG. 3. Here, the MAC address of the control virtual machine 206, which is different from the host MAC address, is present. Thus, as illustrated in FIG. 15A, the MAC address of the control virtual machine 206 is set as the source MAC address (Src) of the request packet. As illustrated in FIG. 15B, the MAC address of the control virtual machine 206 that serves as the source, instead of the host MAC address, is set as the destination MAC address of the response-to-request packet. The MAC address of a control virtual machine 206 that serves as the source is set in the payload. As illustrated in FIG. 15C, the MAC address of the source control virtual machine 206 included in the payload of the response-to-request packet, instead of the host MAC address, is set as the destination MAC address of the ACK packet.

Due to the foregoing packet configuration, the MAC addresses accumulated in some of the FDBs change. However, the MAC addresses of the virtual machines to be used in the process are substantially the same. Accordingly, there may be no substantial difference in processes of the management server 100.

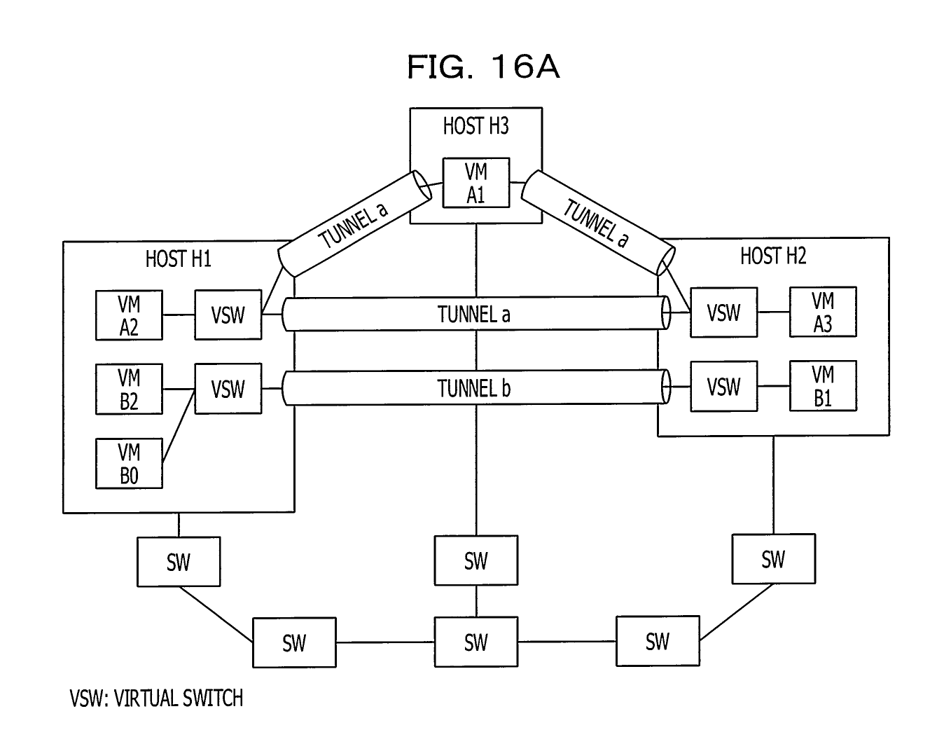

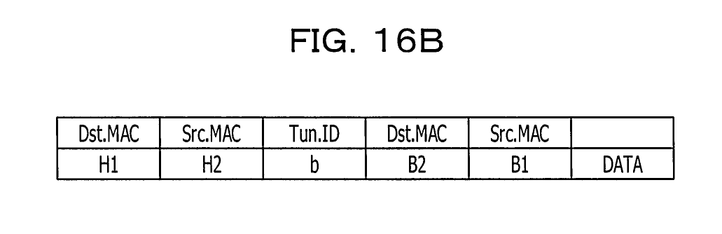

FIG. 16A illustrates an example of tunneling technology. FIG. 16B illustrates an example of tunneling technology. As illustrated in FIG. 16A, in the tunneling technology, an isolation is achieved by constructing one or more logical tunnels for each tenant relative to the physical switches. For example, a tunnel ID ‘a’ is assigned to the tenant A, and a tunnel ID ‘b’ is assigned to the tenant B. Virtual machines Al to A3 belonging to the tenant A communicate with each other through tunnels a, and virtual machines B0 to B2 belonging to the tenant B communicate with each other through a tunnel b. In this case, as illustrated in FIG. 16B, when a packet is transmitted from the virtual machine B1 to the virtual machine B2, the OS of the host H2 performs encapsulation. In the packet to be transmitted, the MAC address ‘H2’ of the host H2 is set as the source MAC address, the MAC address ‘H1’ of the host H1 is set as the destination MAC address, and the tunnel ID ‘b’ is set. Subsequently, the MAC address ‘B2’ of destination virtual machine and the MAC address ‘B1’ of source virtual machine are set in the packet. The OS of the destination host H1 removes data up to the tunnel ID and outputs to the virtual switch (VSW) identified by the tunnel ID.

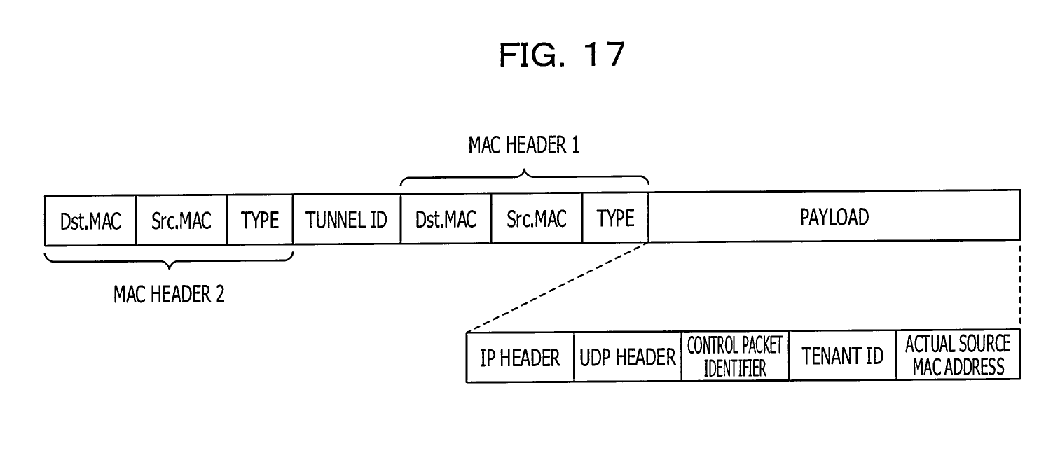

FIG. 17 illustrates an example of a control packet format. For example, when the tunneling technology is in use, MAC addresses of virtual machines may not be accumulated in the switch FDBs, and the data indicative of the extent of failure effect may not be generated.

Thus, in the case where the tunneling technology is used, the control packet process section 202 generates a control packet illustrated in FIG. 17.

In FIG. 17, a MAC header 1 and a portion that follows the a MAC header 1 may be substantially the same as the packet format illustrated in FIG. 11A. Here, the packet is encapsulated and additionally includes a MAC header 2. Thus, the destination MAC address (Dst. MAC address) and the source MAC address (Src. MAC address) that are set in the MAC header 2 are the same as the destination MAC address and the source MAC address of the MAC header 1. The MAC header 2 includes, in the type, an ID for identifying the tunnel protocol. A tunnel ID that corresponds to a tenant ID of the tenant relating to the deployment or migration is set as the tunnel ID.

According to the foregoing control packet exchange, MAC addresses of virtual machines are set in physical switch FDBs. Thus, processes of a management server may be substantially the same as the processes of the management server 100 illustrated in FIG. 1 or FIG. 2.

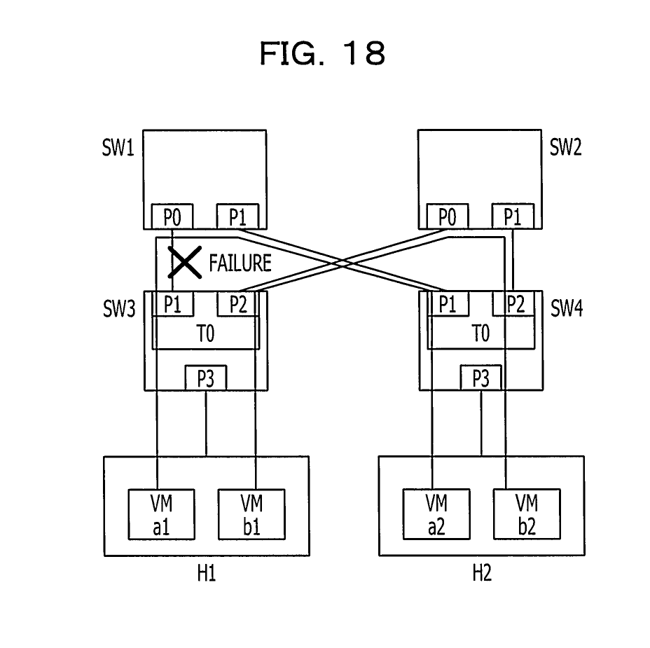

The use of the foregoing control packet may enable to cope with the case where a simple network and a link aggregation (LAG) are used. FIG. 18 illustrates an example of a network of a link aggregation. For example, as illustrated in FIG. 18, a switch SW3 is coupled to the switches SW1 and SW2, and a switch SW4 is coupled to the switches SW1 and SW2. The communication relating to the tenant A is performed via a path that goes through the switches SW3, SW1, and SW4. The communications relating to the tenant B is performed via a path that goes through the switches SW3, SW2, and SW4. Switching of the path is performed at the switch SW3 and the switch SW4 according to the tunnel ID. In the LAG, a plurality of ports is logically integrated. Thus, the port P1 and the port P2 are logically integrated at the switch SW3. A logical port number T0 is assigned to these ports, and this port number T0 is used in registering at the FDB. In such a case, when, for example, a failure occurs at a link between the switch SW1 and the switch SW3, it may be determined that the tenant B is also affected if only the host MAC address is registered in the FDB.

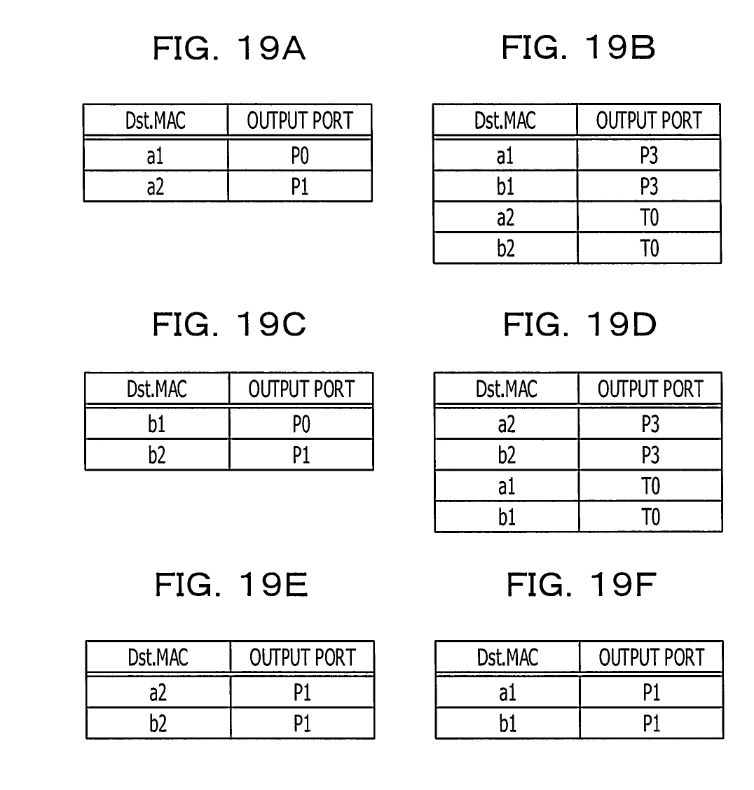

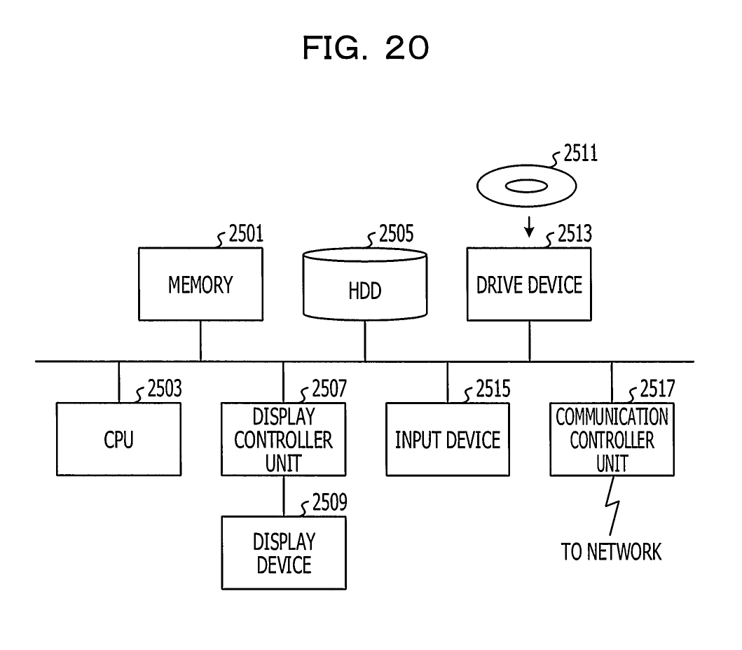

FIG. 19A illustrates an example of data included in a switch. FIG. 19B illustrates an example of data included in a switch. FIG. 19C illustrates an example of data included in a switch. FIG. 19D illustrates an example of data included in a switch. FIG. 19E illustrates an example of data included in a pseudo switch of host. FIG. 19F illustrates an example of data included in a pseudo switch of host. The switch in FIG. 19A to 19F may be the noted switch FDB. FIG. 20 illustrates an example of function blocks of a computer. For example, according to the foregoing control packet exchange, the FDB of the switch SW1 may retain data as illustrated in FIG. 19A. For example, virtual machines of the tenants A and B may be deployed at the same time. The FDB of the switch SW3 may retain data as illustrated in FIG. 19B. The FDB of the switch SW2 may retain data as illustrated in FIG. 19C. The FDB of the switch SW4 may retain data as illustrated in FIG. 19D. The host H1 may retain pseudo FDB data as illustrated in FIG. 19E. The host H2 may retain pseudo FDB data as illustrated in FIG. 19F.

As illustrated in FIG. 18, when a failure occurs at a link between the switch SW1 and the switch SW3, a combination of the port numbers and the device IDs relating to a port P0 of the switch SW1 and the port T0 of the switch SW3 is identified. A MAC address ‘a1’ is extracted from FDB data of the switch SW1 (FIG. 19A), and MAC addresses ‘a2’ and ‘b2’ are extracted from FDB data of the switch SW3 (FIG. 19B). The combination of MAC addresses is not generated for the MAC address ‘b2’ because the MAC address ‘b2’ is a MAC address of virtual machine of the tenant B. Accordingly, the MAC address ‘b2’ is not included in the data indicative of the extent of failure effect. A resultant combination is a combination of the MAC addresses ‘a1’ and ‘a2’. For example, it may be correctly assessed that only the tenant A is affected.

For example, the foregoing function blocks of the management server 100 is an example, and may not be coincide with a program module configuration. The process flow may be modified provided that it still produces substantially the same result.

FIG. 20 illustrates an example of function blocks of a computer. The management server 100 and the hosts may be computer apparatuses. As illustrated in FIG. 20, a memory 2501, a CPU 2503, a hard disk drive (HDD) 2505, a display controller unit 2507 connected to a display device 2509, a drive device 2513 for a removable disc 2511, an input device 2515, and a communication controller unit 2517 for network connection are coupled through a bus 2519. The operating system (OS) and an application program for executing the foregoing processes are stored in the HDD 2505, and read out from the HDD 2505 to the memory 2501 when the CPU 2503 executes the application program. The CPU 2503 controls the display controller unit 2507, the communication controller unit 2517, and the drive device 2513 to perform some operations in response to the process of the application program. Data produced during the execution of the process may be mostly stored in the memory 2501. However, such data may alternatively be stored in the HDD 2505. The application program for executing the foregoing processes may be stored in the computer-readable removable disc 2511 for distribution, and installed in the HDD 2505 through the drive device 2513. Alternatively, the application program may be installed in the HDD 2505 via a network such as Internet and the communication controller unit 2517. The computer apparatus achieves each of the foregoing functions by allowing hardware such as the aforementioned CPU 2503, the memory 2501, and the like and programs such as the OS, the application program, and the like, to organically work together in cooperation.

In an information processing method, (A) a first virtual machine is deployed or migrated to one of a plurality of information processing apparatuses that are coupled through one or more communication devices. In response to the deployment or migration, a management section exchanges a control packet through the one or more communication devices on behalf of virtual machines that are managed by this management section and belong to a group to which the first virtual machine belongs. The management section is included in each unit of the plurality of information processing apparatuses and manages virtual machines running on the information processing apparatus. (B) After the control packet exchange, correspondence data between the port identifier and the destination address with regard to the group to which the first virtual machine belongs are obtained from each of the one or more communication devices. (C) From the obtained correspondence data, a destination address is extracted. This destination address relates to an identifier of a first communication device that is one of the one or more communication devices and an identifier of a first port of the first communication device. (D) Output data is generated by using the extracted destination address.

According to the foregoing process, the effect of failure is determined in units of virtual machines.

In the information processing method, (E) a corresponding second destination address may be extracted from the obtained correspondence data based on an identifier of a second communication device that is one of the one or more communication devices and an identifier of a second port of the second communication device. The first destination address and the second destination address may be combined for each group. For example, the foregoing process may enable to cope with a link-down between switches.

In the process (B), (b1) data including an address of a communication partner may be obtained from the management section included in each unit of the plurality of information processing apparatuses, for the group to which the first virtual machine belong. In this case, in the information processing method, (F) the address of a communication partner relating to an identifier of a specific information processing apparatus or an identifier of the management section included in this specific information processing apparatus may be extracted from the data obtained from the management section. In the process (D), the first destination address and the extracted address of a communication partner may be combined for each group. In this way, the foregoing process may enable to cope with a link-down between a host and a switch.

In a packet exchanging method, (A) a first packet including an identifier of a designated group is broadcasted in response to a request from an information processing apparatus that manages a plurality of information processing apparatuses that are coupled through one or more communication devices. This request includes a designation of a group of a virtual machine running on one of the plurality of information processing apparatuses. (B) As a response to the first packet, when a second packet is received from another information processing apparatus of the plurality of information processing apparatuses, a third packet is transmitted to an address of the another information processing apparatus. The second packet includes an address of the virtual machine belonging to the designated group as the source address and the address of the another information processing apparatus. The third packet includes, as the source address, the virtual machine belonging to the designated group in its own information processing apparatus. (C) When the third packet including an identifier of a second group is received from another information processing apparatus of the plurality of information processing apparatuses, it is determined whether or not a virtual machine belonging to the second group is running on its own information processing apparatus. (D) When a virtual machine belonging to the second group is running on its own information processing apparatus, a fourth packet including an address of the virtual machine as the source address is transmitted to the another information processing apparatus as a response to the third packet.

The foregoing process allows the current virtual machine execution status to be correctly reflected in a switch FDB.

In the packet exchanging method, (E) when the second packet is received, the source address of the second packet is retained. (F) When a fifth packet is received from another information processing apparatus as a response to the fourth packet, the source address of the fifth packet is retained. The fifth packet includes, as the source address, an address of another virtual machine belonging to the second group and running on the another information processing apparatus. (G) The retained source address may be transmitted to the information processing apparatus that performs the management in response to a request from the information processing apparatus that performs the management. The foregoing process may be performed to cope with a failure that occurs between a host and a switch.

A program may be generated to enable a processor (or a computer) to perform the foregoing process. The program may be stored in, for example, a storage device or a computer-readable storage medium such as a flexible disk, a CD-ROM, a magneto-optical disc, a semiconductor memory, a hard disk, or the like. Intermediate process results may be temporarily stored in a storage device such as a main memory, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing method, comprising:
transmitting, via a first communication device of a plurality of communication devices configured to couple a plurality of information processing apparatuses, a control packet to a first information processing apparatus of the plurality of information processing apparatuses based on a deployment of a first virtual machine to the first information processing apparatus;
obtaining, from the first communication device, correspondence data between a port identifier and a destination address regarding a first group to which the first virtual machine belongs; and
extracting, from the correspondence data, a first destination address relating to a first identifier of the first communication device and a first port identifier of the first communication device.

2. The information processing method according to claim 1, further comprising:
extracting, from the correspondence data, a second destination address based on a second identifier of a second communication device of the plurality of communication devices and an second port identifier of the second communication device.

3. The information processing method according to claim 1, further comprising:
combining the first destination address and the second destination address.

4. The information processing method according to claim 1, further comprising:
obtaining data including a third destination address for the first group; and
extracting, from the data, a third identifier of a third information processing apparatus of the plurality of information processing apparatuses.

5. The information processing method according to claim 1, further comprising:
extracting, from the data, a third identifier of a management section included in the third information processing apparatus.

6. The information processing method according to claim 4, further comprising,
combining the first destination address and the third destination address.

7. The information processing method according to claim 1, wherein
the plurality of communication devices includes a switch.

8. An information processing method comprising:
broadcasting a first packet including an identifier of a first group in response to a request from a first information processing apparatus of a plurality of information processing apparatuses that are coupled through a plurality of communication devices, the request identifying the first group corresponding to a first virtual machine to be executed in at least one of the plurality of information processing apparatuses;
receiving a second packet from a second information processing apparatus of the plurality of information processing apparatuses as a response to the first packet, the second packet identifying an address of the first virtual machine as a source address and including an address of the second information processing apparatus;
transmitting a third packet to the address of the second information processing apparatus, the third packet identifying the first virtual machine as the source address;
determining whether a second virtual machine belonging to a second group is running when receiving the third packet from the second information processing apparatus; and
transmitting a fourth packet identifying an address of the second virtual machine as the source address to the second information processing apparatus as a response to the third packet when the second virtual machine is running.

9. The information processing method according to claim 6, further comprising:
retaining the source address of the second packet;
receiving a fifth packet from the second information processing apparatus as a response to the fourth packet, the fifth packet identifying, as the source address, an address of a third virtual machine belonging to the second group and running on the second information processing apparatus; and
retaining the source address of the fifth packet.

10. The information processing method according to claim 7, further comprising:
transmitting a retained source address to the second information processing apparatus in response to a request from the first information processing apparatus.

11. An information processing apparatus comprising:
circuitry configured to
transmit, via a first communication device of a plurality of communication devices configured to couple a plurality of information processing apparatuses, a control packet to a first information processing apparatus of the plurality of information processing apparatuses based on a deployment of a first virtual machine to the first information processing apparatus;
obtain, from the first communication device, correspondence data between a port identifier and a destination address regarding a first group to which the first virtual machine belongs; and
extract, from the correspondence data, a first destination address relating to a first identifier of the first communication device and a first port identifier of the first communication device.

12. An information processing apparatus comprising:
circuitry configured to
broadcast a first packet including an identifier of a first group in response to a request from a first information processing apparatus of a plurality of information processing apparatuses that are coupled through a plurality of communication devices, the request identifying the first group corresponding to a first virtual machine to be executed in at least one of the plurality of information processing apparatuses;
receive a second packet from a second information processing apparatus of the plurality of information processing apparatuses as a response to the first packet, the second packet identifying an address of the first virtual machine as a source address and including an address of the second information processing apparatus;
transmit a third packet to the address of the second information processing apparatus, the third packet identifying the first virtual machine as the source address;
determine whether a second virtual machine belonging to a second group is running when receiving the third packet from the second information processing apparatus; and
transmit a fourth packet identifying an address of the second virtual machine as the source address to the second information processing apparatus as a response to the third packet when the second virtual machine is running.
